(19) United States
(12) Patent Application Publication
(10) Pub. No.: US 2022/0132971 A1
(43) Pub. Date: May 5, 2022

(54) SENSOR INTEGRATED JAMMING DEVICE

(71) Applicant: The Regents of the University of California, Oakland, CA (US)

(72) Inventors: Albert Keisuke Matsushita, La Jolla, CA (US); Luis Garcia, San Diego, CA (US); Skye Edwards, San Diego, CA (US); Michael Collins, San Diego, CA (US); Charles Zahl, San Diego, CA (US)

(21) Appl. No.: 17/516,524

(22) Filed: Nov. 1, 2021

Related U.S. Application Data
(60) Provisional application No. 63/108,034, filed on Oct. 30, 2020.

(51) Int. Cl. A42B 3/04

(52) U.S. Cl. CPC A42B 3/046; A42B 3/0486; A42B 3/0453

(57) ABSTRACT

A jammer system includes a jammer unit, a valve coupled to the jammer unit, and a sensor coupled to the valve. The jammer unit includes a jammer media and a membrane including an inlet. The membrane is configured to surround the jammer media. The valve is configured to allow a fluid to pass through the inlet of the membrane. The sensor is configured to cause actuation of the valve to evacuate the fluid from an interior of the membrane. The evacuation of the fluid from the interior of the membrane results in stiffening of the jammer media within the membrane.

### CROSS REFERENCE TO RELATED APPLICATIONS

This application claims priority to U.S. Provisional Patent Application No. 63/108,034, filed on Oct. 30, 2020, and entitled “SENSOR INTEGRATED JAMMING DEVICE,” the contents of which is hereby incorporated by reference in its entirety.

### STATEMENT OF GOVERNMENT SUPPORT

This invention was made with government support under United States Air Force Office of Scientific Research grant number AFOSR-FA9550-15-1-0009. The government has certain rights in this invention.

### FIELD

The subject matter disclosed herein relates to reversible jammer devices and more specifically to sensor integrated jammer devices and jammer devices with relief cuts.

### BACKGROUND

Bracing and protective equipment, as well as soft robotics for medical and endoscopic applications, may require a mechanism that is compliant to increase conformability, increase accessibility, and decrease patient injury in use, and that is rigid to increase support, stability, and protection in use. To balance these considerations, a variable stiffness mechanism may stiffen material within a membrane upon evacuation of fluid from the interior of the membrane. Generally, reversible jamming techniques have poorly balanced the stiffness and conformability considerations, as reversible jamming techniques have resulted in devices that are able to stretch or stiffen, but cannot sufficiently confirm to a structure or return to its original state.

### SUMMARY

Systems, methods, and articles of manufacture, including apparatuses, are provided for a jammer system.

According to some aspects, a jammer system includes a jammer unit, a valve coupled to the jammer unit, and a sensor coupled to the valve. The jammer unit includes a jammer media and a membrane including an inlet. The membrane is configured to surround the jammer media. The valve is configured to allow a fluid to pass through the inlet of the membrane. The sensor is configured to cause actuation of the valve to evacuate the fluid from an interior of the membrane. The evacuation of the fluid from the interior of the membrane results in stiffening of the jammer media within the membrane.

In some aspects, the sensor is one or more of positioned on the jammer unit and positioned within the jammer unit.

In some aspects, the sensor is wirelessly coupled to the valve.

In some aspects, the sensor includes one or more of an accelerometer, a pressure sensor, a heat sensor, a moisture sensor, a proximity sensor, and a sound sensor.

In some aspects, the sensor is configured to cause actuation of the valve when a sensor reading of the sensor meets a threshold sensor reading.

In some aspects, the jammer system includes a controller. The controller includes at least one data processor and at least one memory storing instructions, which, when executed by the at least one data processor, result in operations that include actuating the valve when a sensor reading of the sensor meets a threshold sensor reading.

In some aspects, the sensor is configured to cause actuation of the valve to a first position when a first sensor reading of the sensor is greater than or equal a threshold sensor reading. The sensor is configured to cause actuation of the valve to a second position when a second sensor reading of the sensor is less than the threshold sensor reading. In some aspects, in the first position, the fluid is evacuated from the interior of the membrane, resulting in the stiffening of the jammer media from a relaxed state. In the second position, the fluid is allowed to fill the interior of the membrane, resulting in the jammer media returning to the relaxed state.

In some aspects, the jammer media includes a combined jammer unit formed of a first layer including a first reversibly stiffening material and a second layer including a second reversibly stiffening material.

In some aspects, the jammer media includes a first backing layer, a second backing layer overlapping the first backing layer, and a substrate coupled to the first backing layer and the second backing layer. The substrate includes a substrate material and a plurality of relief cuts defining openings in the substrate material.

In some aspects, the substrate includes a rigid material.

In some aspects, the plurality of relief cuts are positioned in a patterned array of relief cuts.

In some aspects, the substrate includes alternating sets of rows. The alternating sets of rows include a first row that does not have at least one relief cut of the plurality of relief cuts and a second row that has at least one relief cut of the plurality of relief cuts.

In some aspects, the alternating sets of rows are positioned parallel to one another.

In some aspects, the jammer media includes a plurality of ganoids and a plurality of sinusoidal bridges configured to couple the plurality of ganoids.

According to some aspects, a jammer unit includes a first backing layer, a second backing layer overlapping the first backing layer, a substrate coupled to the first backing layer and the second backing layer, and a membrane including an inlet. The substrate includes a substrate material and a plurality of relief cuts defining openings in the substrate material. The membrane is configured to surround the first backing layer, the second backing layer, and the substrate. The jammer unit is configured to stiffen when fluid from an interior of the membrane is evacuated via the inlet.

In some aspects, the substrate includes a rigid material.

In some aspects, the plurality of relief cuts are positioned in a patterned array of relief cuts.

In some aspects, the substrate includes alternating sets of rows. The alternating sets of rows include a first row that does not have at least one relief cut of the plurality of relief cuts and a second row that has at least one relief cut of the plurality of relief cuts.

In some aspects, the alternating sets of rows are positioned parallel to one another.

According to some aspects, a method includes receiving a sensor reading from a sensor coupled to a jammer unit. The jammer unit includes a jammer media and a membrane having an inlet. The membrane is configured to surround the jammer media. The method also includes detecting the sensor reading meets a threshold sensor reading. The method further includes causing, based on the detecting, actuation of a valve coupled to the membrane to cause evacuation of a fluid from an interior of the membrane. The evacuation of the fluid from the interior of the membrane results in stiffening of the jammer media within the membrane.

The details of one or more variations of the subject matter described herein are set forth in the accompanying drawings and the description below. Other features and advantages of the subject matter described herein will be apparent from the description and drawings, and from the claims. The claims that follow this disclosure are intended to define the scope of the protected subject matter.

### DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts an example jammer system, consistent with implementations of the current subject matter;

FIG. 2 schematically depicts an example jammer system, consistent with implementations of the current subject matter;

FIGS. 3A-3B depict an example jammer system, consistent with implementations of the current subject matter;

FIGS. 4A-4C depict example performance plots, consistent with implementations of the current subject matter;

FIGS. 5A-5B depict images of a “flick test”, consistent with implementations of the current subject matter;

FIGS. 6A-6D depict examples of the jammer system in use, consistent with implementations of the current subject matter;

FIG. 7 schematically depicts an example of a jammer unit, consistent with implementations of the current subject matter;

FIG. 8 schematically depicts an example substrate for a jammer device, consistent with implementations of the current subject matter;

FIGS. 9A-9C depict images of an example jammer device, consistent with implementations of the current subject matter;

FIGS. 10A-10B depict a performance comparison between jammer devices, consistent with implementations of the current subject matter;

FIGS. 11A-11B depict example performance plots, consistent with implementations of the current subject matter;

FIGS. 12A-12B depict images of a bend test, consistent with implementations of the current subject matter;

FIGS. 13A-13D depict an example ganoid geometry for a jammer device, consistent with implementations of the current subject matter;

FIG. 14 depicts a flowchart illustrating a method of operating a jammer unit, consistent with implementations of the current subject matter; and

FIG. 15 depicts a block diagram illustrating a computing system, in accordance with some example implementations.

When practical, similar reference numbers denote similar structures, features, and/or elements.

### DETAILED DESCRIPTION

Bracing, sportswear, stretchers, protective equipment, and soft robotics for medical and endoscopic applications, may require a mechanism that is compliant to increase conformability, increase accessibility, and decrease patient injury in use, and that is rigid to increase support, stability and protection in use. To balance these considerations, a variable rigidity mechanism, such as a jammer unit, may be implemented in which a jammer media is stiffened within a membrane upon evacuation of fluid from the interior of the membrane.

A jammer unit may also be referred to as a jamming membrane, a bladder, a jamming-based mechanism, a manipulator, a vacuum splint, a hermetic envelope, a gas-tight envelope, a pneumatic device, and the like. For example, a jammer unit may include an air-tight membrane containing loose media (e.g., grains, layers, fibers, imbricating scales, wires, and/or the like) that stiffens on evacuation of fluid from the membrane, such as via friction within the loose media and/or interlocking mechanisms of the loose media. In other words, a jammer unit alternates between pliant and stiff states by controlling the differential air pressure within the membrane. In an initial relaxed state, the membrane includes a fluid, such as air, gas, liquid, and/or the like, and the media is in a non-stretched position. In an evacuated state, portions of the media within the membrane are brought into contact with one another and are unable to move past one another, conferring stiffness.

Generally, jamming methods, such as grain jamming, layer jamming, scale jamming, and wire jamming have poorly balanced stiffness and conformability considerations, as reversible jamming techniques have resulted in devices that have experienced poor efficiency of material weight to mechanical property ratios. For example, grain jamming techniques involve a flexible bladder enclosing granular material that stiffens when the fluid is evacuated from the interior of the bladder. Grain jamming techniques have generally resulted in a relatively conformable device that has poor stiffness properties, such as when tensile and penetrative forces are applied to the bladder. When the tensile and penetrative forces are applied to the bladder, the grains separate from one another, thereby reducing the stiffness of the bladder and minimizing the ability of the bladder to resist an applied penetrative force. As such, these jammer units thin out as bending elongates the jammer unit.

As another example, layer jamming techniques involve a flexible bladder enclosing layers of material that stiffen when fluid is evacuated from the interior of the bladder. Layer jamming techniques have generally resulted in a relatively stiff device that has very poor conformability properties. For example, the device may be stiff, but may be unable to bend or conform to an object that the device surrounds. Such devices may also stiffen upon evacuation, but do not entirely return to its original state when fluid is permitted to fill the flexible bladder. Such devices may also be difficult to stretch when the devices are not activated (e.g., when fluid is not evacuated from the bladder), because of the high force required to overcome friction between the layers. These devices also fail to fully return to its original state after being stretched.

Additionally, scale jamming techniques may be used to enhance protective and penetrative resistance properties of a bladder. Scale jamming techniques generally involve scale-like units that overlap to form a protective layer. The protective layer may have high stiffness and penetrative resistance properties, but the protective layer may have a non-uniform thickness and limited conformability properties.

In contrast, the jammer unit consistent with implementations of the current subject matter may have improved stiffness, conformability, and penetration resistance properties. The jammer unit consistent with implementations of the current subject matter may also include a plurality of relief cuts, such as a patterned array of relief cuts and/or kirigami relief cuts, that improve the stiffening and conformability properties of the jammer unit. Such configurations allows the jammer unit consistent with implementations of the current subject matter, to fully return to its original state after being stretched and/or stiffened. Such configurations also reduce the amount of force required to stretch the jammer unit, making it easier for the wearer to use the jammer unit. Thus, the patterned relief cuts can be introduced to otherwise rigid materials to create highly stretchable and morphable structures. The relief cuts may further allow segments of the rigid materials to locally rotate and covert in-plane tensile forces to out-of-plane deformation, significantly increasing the critical strain and improving the mobility of the rigid materials. By implementing the relief cuts, the shear lag effect induced at the edges of the material segments near the relief cuts and partial debonding due to the local out-of-plane deformation reduce the energy release rate of crack propagation, which limits failure of the rigid material.

For example, in some implementations, the jammer unit may include a substrate material, such as silicon carbide, nitrile, and/or the like, that is generally hard or rigid. While jamming techniques, such as grain jamming and layer jamming, and others, allow for the rigid material to stiffen upon evacuation of the fluid from the interior of the membrane of the jammer unit, the rigid substrate material often fails to fully return to its original state after evacuation ends (e.g., when fluid is again permitted to fill the membrane). When such jamming techniques are used when the jammer unit is inactive, such as when no fluid is being evacuated from the bladder, the jammer units may be difficult to stretch due to the high frictional forces of the materials against one another. The jammer unit including relief cuts, consistent with implementations of the current subject matter, may allow the rigid substrate material to sufficiently stiffen upon evacuation of the fluid from the membrane, and fully return to its original relaxed state after evacuation ends. The jammer unit including relief cuts, consistent with implementations of the current subject matter may also allow the rigid substrate material to easily stretch and/or length due at least in part to the out-of-plane deformation of the layers of the jammer unit and/or the relief cuts. Such configurations may also the rigid substrate material to fully return to its original relaxed state after being stretched.

Moreover, in use, jammer units do not have the ability to react to changes in the environment, such as an impact, swelling, heat, and/or the like. For example, jammer units may generally be inactivated, such as when no fluid is being evacuated from the membrane of the jammer unit, or activated, such as when fluid is being evacuated from the membrane of the jammer unit, resulting in a stiffened jammer unit. Both cases (e.g., only activated and only inactivated) react poorly to changes in the environment, such as an impact, swelling of a body part, a rapid acceleration, a rapid deceleration, a rapid approach of an object, and/or the like. Accordingly, such configurations can lead to injury or discomfort for the wearer.

The jammer unit consistent with implementations of the current subject matter may be coupled to a sensor and a valve. The sensor may cause actuation of the valve, in response to a change in the environment. Actuation of the valve, in turn, causes evacuation of the fluid from the membrane of the jammer unit as a result of the change in environment. This reactionary jamming technique may improve the comfort of the wearer and reduce injury to the wearer. The sensor may also allow for improved control of the evacuation of fluid from the jammer unit to stiffen the jammer unit. For example, the sensor integrated with the jammer unit may allow for control over an amount of vacuum pressure and a change in the amount of vacuum pressure applied to the jammer unit (e.g., sufficiently stiff, but not too stiff to prevent asphyxiation). The sensor may also provide for control over the timing of applied vacuum, as described above. The sensor may also provide control over the location of the applied vacuum (e.g., gradient control) within the jammer unit. For example, a helmet lining jammer unit may stiffen to a greater degree closer to an impacted helmet surface and to a lesser degree closer to a surface in contact with the head of the wearer. In another example, a case may be stiffened to a higher degree at the point of injury. The stiffness can be increased and/or decreased in response to the sensor detecting swelling of the tissue of the patient.

Accordingly, the jammer unit, consistent with implementations of the current subject matter, may exhibit unhindered freedom of motion when inactive, such as when fluid is not being evacuated from the interior of the membrane. The jammer unit provides uniform contact with the wearer with improved distribution of pressure. Additionally and/or alternatively, the jammer unit provides an adjustable support in response to change in the environment or wearer condition.

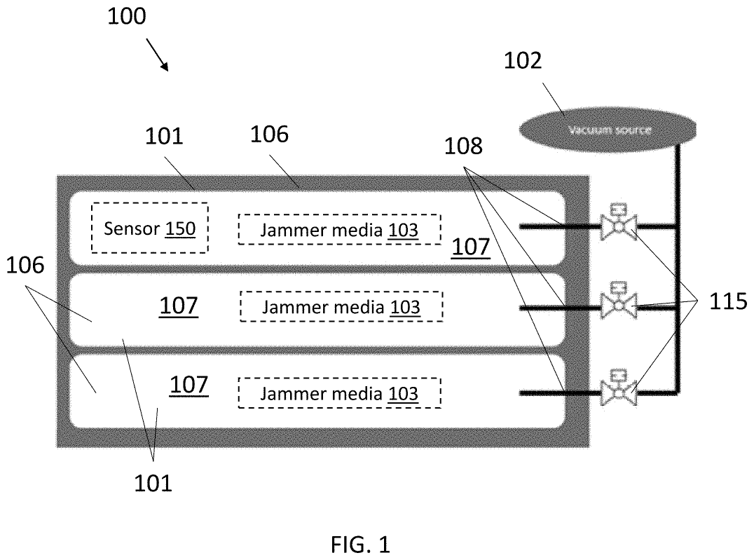

FIG. 1 illustrates an example of a jammer system 100, consistent with implementations of the current subject matter. The jammer system 100 includes one or more (e.g., one, two, three, four, five, ten, or more) jammer units 101, a valve 115 corresponding to each jammer unit 101, and a vacuum source 102 coupled to the valve 115. The vacuum source 102 may include a stored vacuum, an electronic pump, a manual pump, and/or the like. The jammer system 100 may additionally and/or alternatively include a sensor 150.

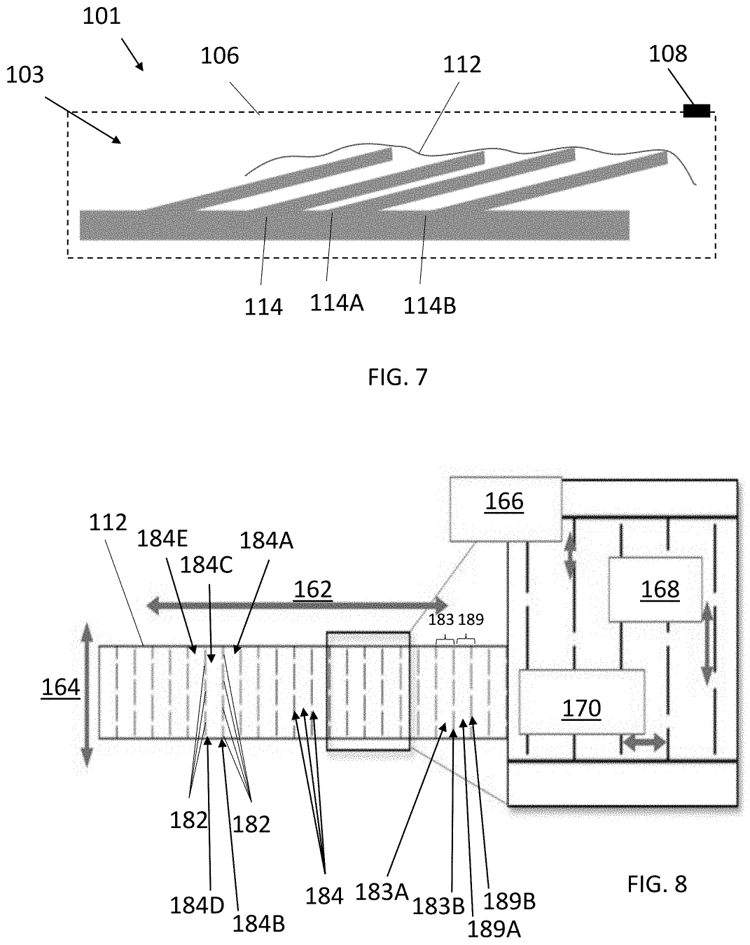

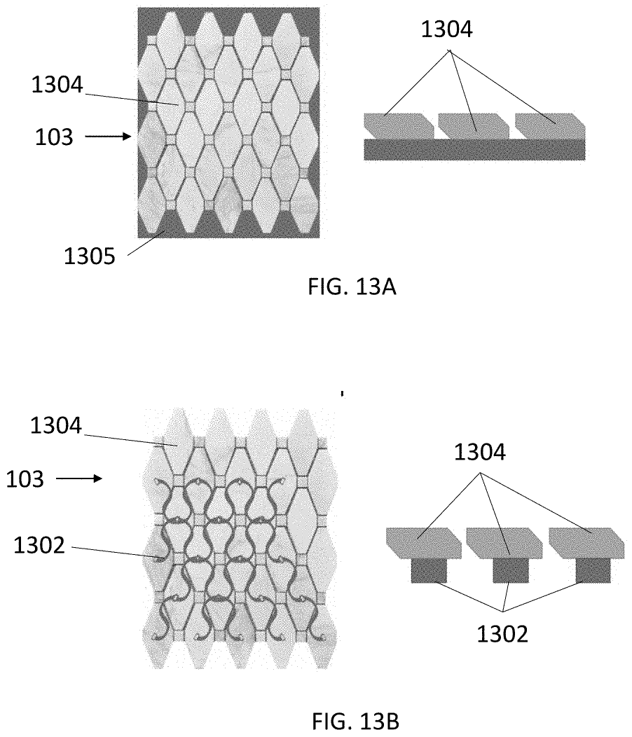

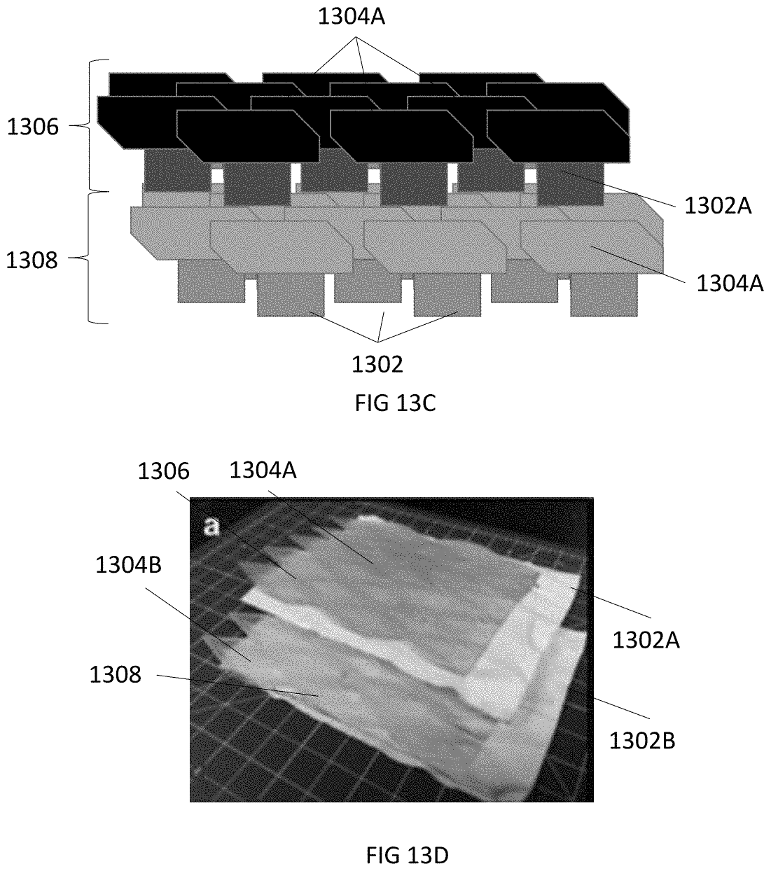

The jammer unit 101 includes a jammer media 103 and a membrane 106. The jammer media 103 may be formed using different jamming techniques, such as one or more of grain jamming, layer jamming, and scale jamming techniques, to improve the stiffness, conformability, and penetrative resistance properties of the jammer unit 101. Additionally and/or alternatively, the jammer media 103 may include a plurality of relief cuts (see FIGS. 7-12B). Additionally and/or alternatively, the jammer media 103 may include a plurality of ganoids (see FIGS. 13A-13D). Additionally and/or alternatively, the jammer media 103 can be defined by a combined jammer unit include multiple layers. For example, the jammer media 103 may include a first layer formed of a layered material (e.g., one or more layers of a reversibly stiffening material), a second layer formed of a granular material (e.g., one or more grains of a reversibly stiffening material), a third layer formed of a plurality of ganoids, and/or a fourth layer formed of a wire material, and so on.

In some implementations, each jammer unit 101 of the jammer system 100 includes a different jammer media 103. As an example, FIG. 1 shows a jammer system 100 including three jammer units 101 positioned adjacent to one another in a stacked configuration. In this example, a first jammer unit may be filled with stiff ganoids and be stiffened to provide penetrative protection. A second jammer unit, adjacent to the first jammer unit, and/or a third jammer unit positioned adjacent to the second jammer unit, may be filled with progressively softer jamming media 103 and be jammed (e.g., stiffened) to a lower degrees relative to the first jammer unit. In this example, a wearer may wear the jammer units around the neck of the wearer. the first jammer unit may provide protection and be positioned farthest away from the wearer, relative to the second and third jammer units. Further, in this example, the third jammer unit may be positioned closest to and/or in contact with the wearer to improve the wearer's comfort, while still providing protection. In an example in which the wearer is engaged in strenuous or potentially dangerous activities, the second and third jammer units may be stiffened to a higher degree to prioritize safety over comfort. After the strenuous or potentially dangerous activities, the second and/or third jammer units can be vented to improve the comfort to the wearer, while maintaining the stiffness of the first jammer unit for added protection. In some implementations, the multiple jammer units 101 are positioned in a biaxial or triaxial weave configuration. Each of the jammer units may be separately controlled. In some instances, separately controlling each of the jammer units creates anisotropic mechanical properties to provide protection and/or comfort to the wearer.

The membrane 106 may include a flexible material, such as silicone, rubber, mylar, latex, nylon, polychloroprene, thermoplastic (e.g., polyethylene, polypropylene, and the like), natural rubber, 3D printed materials, or combinations with rigid polymers or other materials, and the like. The membrane 106 may have a relatively low gas permeability. The membrane 106 may surround the jammer media 103, and enclose a fluid 107, such as air, liquid, and/or gas, within an interior of the membrane 106. The membrane 106 may include the inlet 108, which forms an opening or other passageway into the interior of the membrane 106, through which the fluid 107 may be evacuated from the interior of the membrane 106 to stiffen the corresponding jammer unit 101.

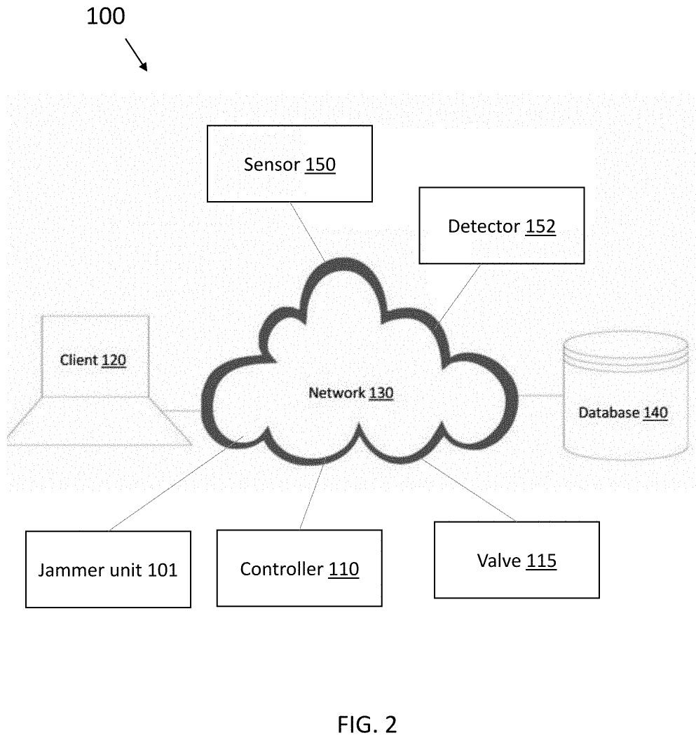

The inlet 108 may be coupled to the valve 115. The valve 115 may include a solenoid valve, among other types of actuating valves. For example, the valve 115 may be opened and/or closed. When the valve 115 is opened, the vacuum source 102 may evacuate the fluid 107 from the interior of the membrane 106 to stiffen the jammer unit 101 and/or the jammer media 103 within the membrane 106. The valve 115 may be actuated to be opened (e.g., allow evacuation of the fluid) and/or closed (e.g., prevent evacuation of the fluid). The valve 115 may be actuated upon receipt of a control signal via a wired and/or wireless connection to a controller 110, which is described in more detail below with respect to FIG. 2. The valve 115 may separate the jammer unit 101 from the vacuum source 102.

To stiffen each jammer unit 101, air may be evacuated from the interior of the membrane 106, such as via the inlet 108. Evacuating the fluid from the membrane 106 causes the jammer media 103 to be compressed, generating friction within portions of the jammer media 103. As an example, the jammer media 103 may include a granular material. In this example, friction may be generated between abutting grains of the granular material when the fluid is evacuated from the interior of the membrane 106. Likewise, in an example in which the jammer media 103 includes a layered material, friction may be generated between adjacent layers of the layered material when the fluid is evacuated from the interior of the membrane 106. The generated friction and compressed layers and grains causes the jammer unit to stiffen. In some implementations, venting the jammer unit 101 by, for example, opening the inlet 108, actuating the valve to close the valve, or pumping the fluid into the interior of the membrane 106, reverses the stiffening process, allowing the portions of the jammer media 103 to slide past one another to restore the pliancy of the jammer unit 101.

Referring to FIG. 1, the sensor 150 is configured to cause actuation of the valve 115 to evacuate the fluid 107 from the interior of the membrane 106. As noted above, the evacuation of the fluid from the interior of the membrane results in stiffening of the jammer media 103 within the membrane 106. The sensor 150 may include one or more sensors, such as one or more of an accelerometer, a pressure sensor, a heat sensor, a moisture sensor, a proximity sensor, and a sound sensor, among other sensors. The sensor 150 may include a stretchable sensor. The sensor 150 may be positioned on the jammer unit 101, embedded within the jammer unit 101, wirelessly coupled to the jammer unit 101, wirelessly coupled to the valve 115, and/or the like. For example, the sensor 150 may be positioned within the membrane 106, the jammer media 103, a backing layer (e.g., the backing layer 114 and/or the backing layer 1305) of the jammer media 103, and/or the like. The sensor 150 may additionally and/or alternatively be positioned on an external surface of the jammer unit 101 and/or be separately coupled to the jammer unit 101. The sensor 150 may also be configured to detect a degree of deformation in one or more components of the jammer unit 101. For example, when the sensor 150 is incorporated into the backing layer of the jammer media 103, the sensor 150 may detect the degree of deformation of the jammer media 103.

The sensor 150 is configured to record one or more sensor readings, such as an acceleration, a rate of acceleration, a pressure, a temperature, an amount of moisture, a distance from an object, a sound level, and/or the like. In some implementations, the sensor 150 is configured to cause (e.g., via the controller 110) actuation of the valve 115 when at least one of the sensor readings meets a threshold sensor reading.

For example, the controller 110 may receive the one or more sensor readings from the sensor 150. When the controller 110 determines that the one or more sensor readings meets (e.g., is greater than or equal to) the threshold sensor reading, the controller actuates the valve 115 to, for example, stiffen the jammer unit 101 and/or the jammer media 103. Additionally and/or alternatively, when the controller 110 determines the one or more sensor readings is less than or equal to the threshold sensor reading, the controller may actuate the valve 115 to vent the jammer unit 101 to allow fluid to fill the jammer unit 101.

In other words, the sensor 150 is configured to cause actuation of the valve 115 to a first position when a first sensor reading of the sensor 150 is greater than or equal a threshold sensor reading and/or the sensor 150 is configured to cause actuation of the valve 115 to a second position when a second sensor reading of the sensor 150 is less than the threshold sensor reading. In the first position, the fluid is evacuated from the interior of the membrane 106, resulting in the stiffening of the jammer media 103 from a relaxed state to a stiffened state. In the second position, the fluid is allowed to fill the interior of the membrane 106, resulting in the jammer media 103 returning to the relaxed state.

Additionally and/or alternatively to the sensor 150, the jammer system 100 may include a detector 152 (see FIG. 2). The detector 152 can receive a wired and/or wireless signal indicating one or more of an acceleration, a rate of acceleration, a pressure, a temperature, an amount of moisture, a distance from an object, a sound level, and/or the like.

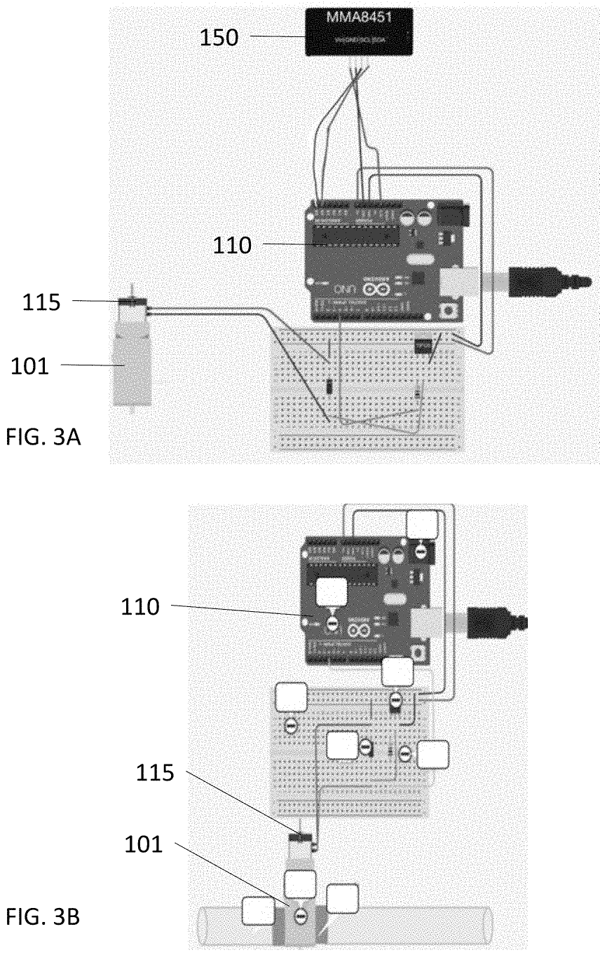

FIG. 2 schematically depicts an example of the jammer system 100 consistent with implementations of the current subject matter. FIGS. 3A and 3B illustrate another example of the jammer system 100 consistent with implementations of the current subject matter. As shown in FIG. 2, the jammer system 100 may include the jammer unit 101, the valve 115, the sensor 150, the controller 110, and/or the detector 152. The jammer system 100 may additionally and/or alternatively include a client 120 and/or a database 140.

As shown in FIG. 2, the controller 110, the client 120, the database 140, the jammer unit 101, the valve 115, the sensor 150, and/or the detector 152 may be communicatively coupled via a network 130. The network 130 may be any wired and/or wireless network including, for example, a wide area network (WAN), a local area network (LAN), a virtual local area network (VLAN), a public land mobile network (PLMN), the Internet, and/or the like.

The database 140 may be configured to store one or more sensor readings from the sensor 150. In some example implementations, the client 120 may be a mobile device including, for example, a smartphone, a tablet computer, a wearable apparatus, and/or the like. However, it should be appreciated that the client 120 may be any processor-based device including, for example, a laptop computer, a workstation, and/or the like. In some implementations, the client 120 includes an application, such as a mobile application, which may be a type of application software configured to run on a mobile device or any processor-based device. The sensor readings may be monitored and/or accessed via the client 120. In some implementations, actuation of the valve 115 may be controlled via the client 120, such as upon receipt of an input via the client 120.

The controller 110 may include at least one data processor and at least one memory storing instructions for execution. The controller 110 may be coupled to and/or be integrated with the jammer unit 101. The controller 110 may receive the one or more sensor readings from the sensor 150. The controller 110 may compare the one or more sensor readings to a threshold sensor reading. The controller 110 may determine that the one or more sensor readings meets (is greater than or equal to) the threshold sensor reading and/or that the one or more sensor readings is less than the threshold sensor reading, and as a result, actuate the valve 115. The configurations of the jammer system 100 may desirably provide for reactive fluid evacuation of the jammer unit 101 that results in reduced harm to the wearer and quicker dampening upon impact.

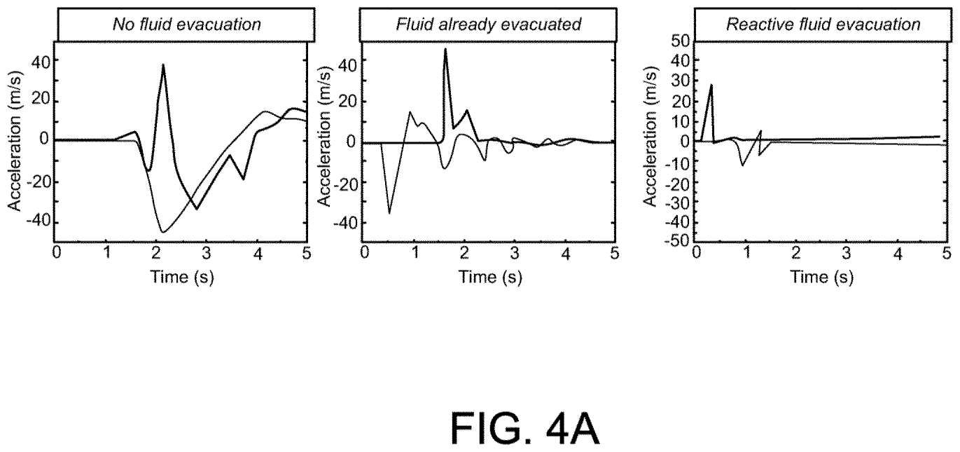

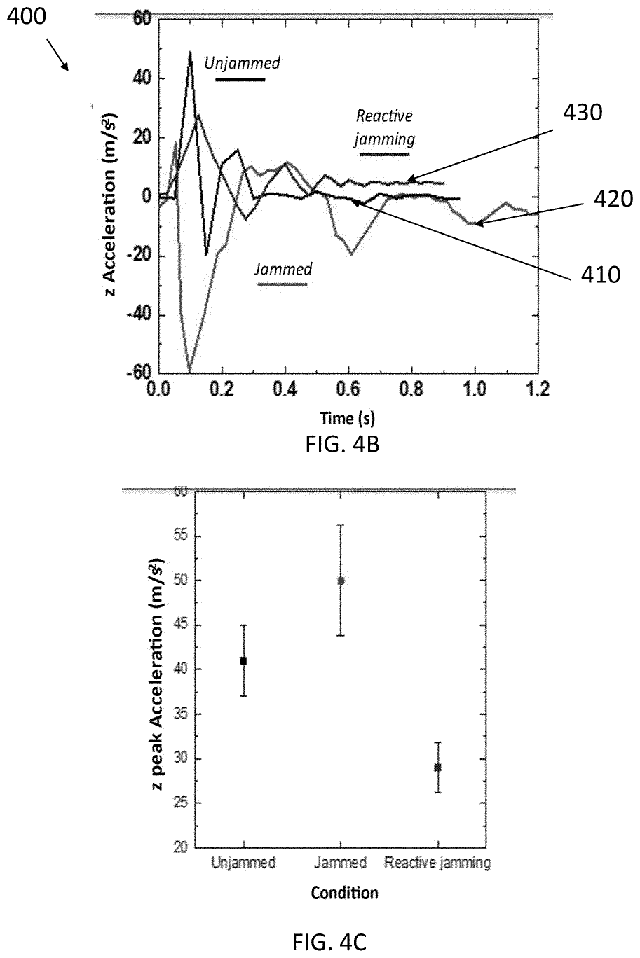

For example, FIGS. 4A-4C depict results of a “flick test”, comparing an unjammed jammer (e.g., a jammer unit in which no fluid has been evacuated—“no fluid evacuation”), a jammed jammer unit (e.g., a jammer unit in which fluid is already evacuated—“fluid already evacuated”), and a reactive jammer unit (e.g., the jammer unit 101, in which the controller causes actuation of the valve based on one or more sensor readings). As part of the flick test, the unjammed, jammed, and reactive jamming jammer units were coupled to an accelerometer (e.g., the sensor 150). Each jammer unit was flicked with approximately equal force, and the acceleration resulting from the flick was recorded over time by the accelerometer. As shown in FIG. 4A, the “no fluid evacuation” jammer unit exhibited a large acceleration and continued to swing at a high acceleration over a period of time (e.g., 5 seconds), without fully dampening the acceleration. In this example, the peak acceleration was greater than 40 m/s. The “fluid already evacuated” jammer unit exhibited an even larger peak acceleration, since the already stiffened jammer unit efficiently absorbed the force from the flick. The acceleration of this jammer unit was dampened after approximately 4 seconds. Finally, the “reactive fluid evacuation” jammer unit, such as the jammer unit 101 described herein, exhibited a peak acceleration of approximately 30 m/s and dampened in under 2 seconds. This comparison illustrates that the reactive evacuation of the jammer unit induced by the accelerometer signal significantly diminishes acceleration of the jammer unit.

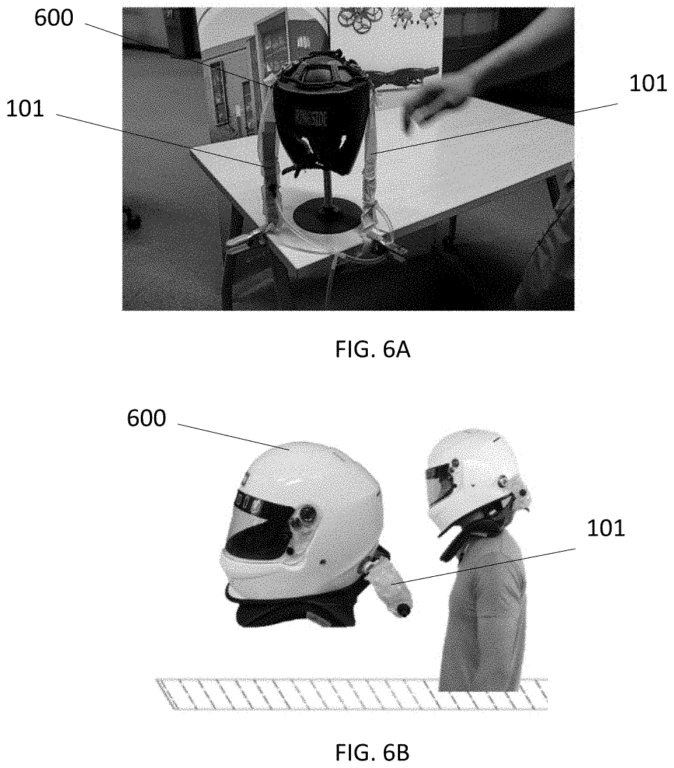

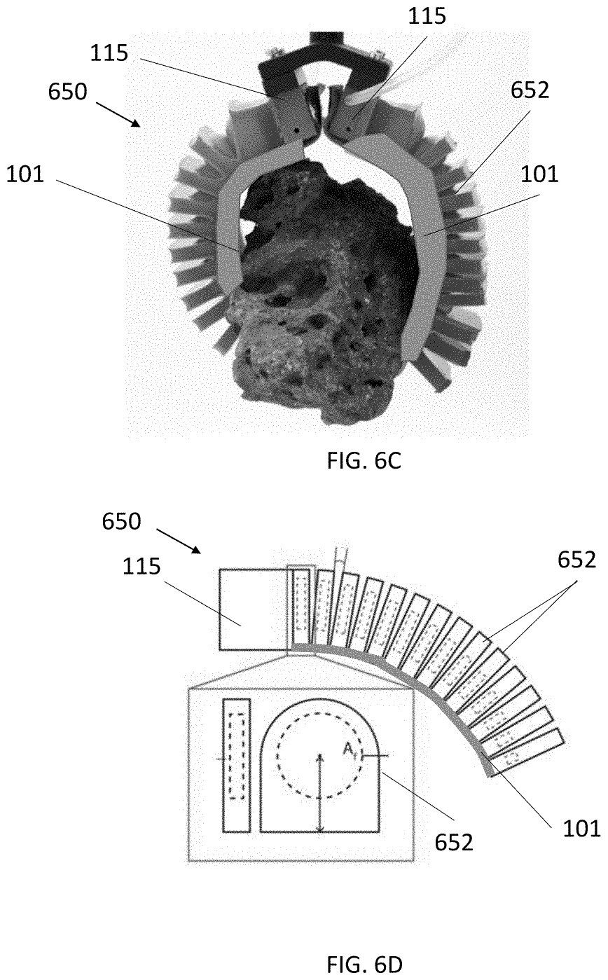

FIG. 4B illustrates a similar comparison graph 400, comparing recorded accelerations during a flick test of an unjammed jammer unit at 410, a jammed jammer unit at 420, and a reactive jamming jammer unit (e.g., the jammer unit 101) at 430. In this test, each jammer was coupled to an accelerometer. Each jammer was flicked, and the accelerations of each jammer unit was measured by the accelerometer over 1.2 seconds. As shown in FIG. 4B and 4C, the jammed and unjammed jammer units exhibited high peak accelerations and took a relatively long period of time to dampen and come to rest. On the other hand, the reactive jamming jammer unit exhibited the lowest peak acceleration and dampened the acceleration the quickest. As a result, activating the jammer unit by stiffening the jammer unit when the controller 110 determines the sensor readings meet the threshold sensor reading decreases peak acceleration and results in a reduced time to dampen the acceleration. Such configurations can provide improved performance and safety for the wearer in various applications (described in more detail with respect to FIGS. 6A and 6B).

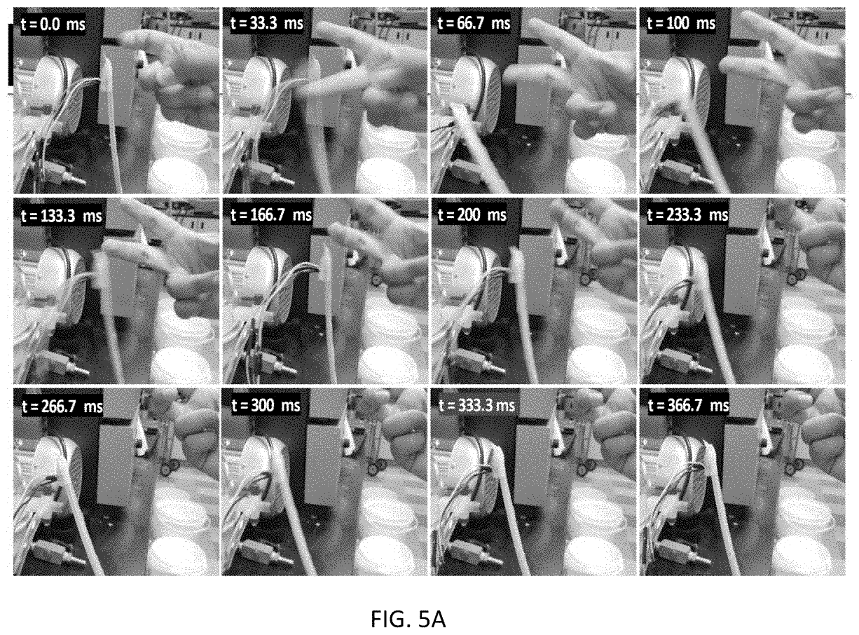

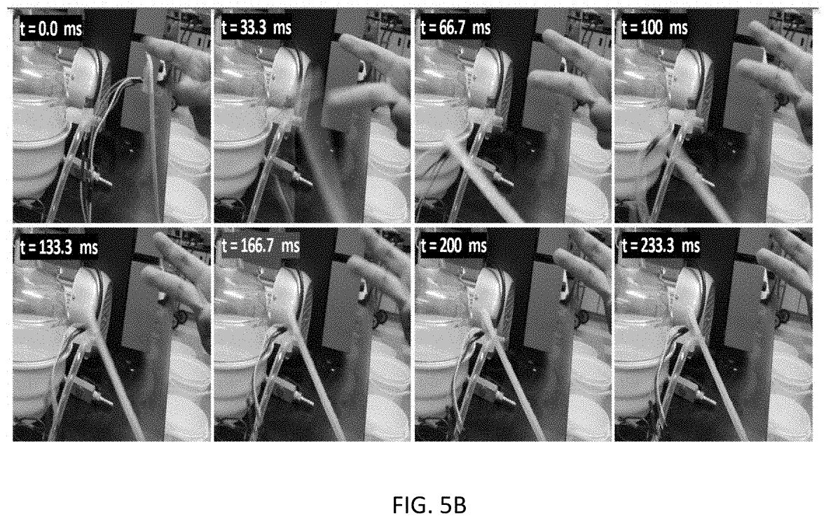

FIGS. 5A and 5B illustrate images captured during the flick test. For example, FIG. 5A illustrates images showing the unjammed jammer unit during the flick test. As shown in FIG. 5A, the unjammed jammer unit continued to move until approximately 333.3 ms. As shown in FIG. 5B, the reactive jamming jammer unit continued to move until approximately 166.7 ms. Thus, the reactive jamming jammer unit decelerated the acceleration caused by the flick in approximately one-half the amount of time compared to the unjammed jammer unit.

As described herein, the jammer unit 101 and the jammer system 100 may be used in various applications, such as to protect the wearer, in gripping applications, and/or the like. As an example, FIGS. 6A and 6B show the jammer unit 101 coupled to a helmet 600. Generally, helmets protect against direct impact and prevent skull fractures. However, helmets can be ineffective against concussion-inducing whiplash, such as in action or contact sports including football, boxing, and automotive racing. Coupling the jammer units 101 to the helmet 600 can help to reduce whiplash during an impact and improve the safety for the wearer.

For example, the jammer units can be coupled to a back and/or sides of the helmet 600 at one end and can be coupled to the wearer or a strap worn by the wearer. During normal use, the jammer units may be inactive. In other words, the fluid from within the jammer units may not be evacuated. Such configurations allow for the wearer to maintain free rotation of their head when wearing the jammer units. When the sensor (e.g., the sensor 150) integrated with the jammer units records a sensor reading that meets the threshold sensor reading, the jammer units are activated, such as by actuating a valve (e.g., the valve 115). As described above with respect to the flick test, such configurations help to significantly reduce movement of the jammer units. In this example in which the jammer unit is coupled to the helmet, the reactive jamming jammer unit configuration helps to quickly decelerate the helmet and in turn, the head of the wearer, such as during an impact. Accordingly, the jammer unit described herein improves the safety of the wearer.

In some implementations, the sensor 150 is an accelerometer. Such configurations may be useful during an impact as the accelerometer can detect an increase in the acceleration of the wearer that is greater than a threshold acceleration. This causes actuation of the valve and evacuation of the jammer unit to stiffen the jammer unit. Additionally and/or alternatively, the sensor 150 may include a proximity sensor. The proximity sensor can be useful, such as during impact sports. The proximity sensor can detect a distance between the wearer and another object, such as another player. When the proximity sensor detects that the other object or player is within a predetermined proximity of the proximity sensor, the proximity sensor can cause actuation of the valve and evacuation of the jammer unit to stiffen the jammer unit. The proximity sensor can be used separate from and/or in combination with the accelerometer to protect the wearer.

In other implementations, a jammer unit can be used as a cast and include integrated moisture, pressure, and/or temperature sensors. These sensors can detect swelling sweating, and/or inflammation in the wearer's tissue in contact with the sensors. When the swelling, moisture, and/or inflammation meets the threshold sensor reading, the sensors cause actuation of the valve and evacuation of the jammer unit to stiffen the jammer unit. Such configurations can provide free motion to the wearer when the wearer is not experiencing swelling, sweating, and/or inflammation, and when those symptoms occur, the jammer unit can help to quickly reduce swelling, sweating, and/or inflammation in the tissue of the wearer.

As another example, FIGS. 6C and 6D illustrate the jammer unit 101 used as part of a gripper 650. For example, the jammer unit 101 may be incorporated in the gripper 650 as a reinforcement component of soft robot grippers 652 of the gripper. For example, when the valve 115 is actuated, the fluid from within each jammer unit 101 is evacuated, stiffening each jammer unit 101. This allows for objects to be gripped by the gripper 650 (and the grippers 652), as the stiffening of the jammer unit 101 lengthens and/or contracts the jammer unit 101, which causes the grippers 652 to be secured around the object being gripped. The jammer unit 101 as part of the gripper 650 may include the jammer unit 101 as shown in FIGS. 7-12, the jammer unit 101 as show in FIGS. 13A-13D, and/or the like.

FIGS. 7-12 illustrate an example of the jammer unit 101, consistent with implementations of the current subject matter. The jammer unit 101 show in FIGS. 7-12 can be implemented as part of the jammer system 100 described herein, and can be coupled to the sensor 150.

The jammer unit 101 includes a plurality of backing layers 114, a substrate 112 coupled to the plurality of backing layers 114, and a membrane 106. In some implementations, the jammer unit 101 includes a jammer media 103, which is defined by the plurality of backing layers 114 and the substrate 112.

The membrane 106 may include a flexible material, such as silicone, rubber, mylar, latex, nylon, polychloroprene, thermoplastic (e.g., polyethylene, polypropylene, and the like), natural rubber, 3D printed materials, or combinations with rigid polymers or other materials, and the like. The membrane 106 may have a relatively low gas permeability. The membrane 106 may surround the plurality of backing layers 114 and the substrate 112, and enclose a fluid, such as air, liquid, and/or gas, within an interior of the membrane 106. The membrane 106 may include the inlet 108, which forms an opening or other passageway into the interior of the membrane 106, through which the fluid 107 may be evacuated from the interior of the membrane 106 to stiffen the corresponding jammer unit 101. The inlet 108 may be coupled to the valve 115 (not shown), which as described herein may include a solenoid valve, among other types of actuating valves.

To stiffen each jammer unit 101, air may be evacuated from the interior of the membrane 106, such as via the inlet 108. Evacuating the fluid from the membrane 106 causes the plurality of backing layers 114 and the substrate 112 to be compressed, generating friction between adjacent backing layers of the plurality of backing layers 114. The generated friction and compressed backing layers 114 causes the jammer unit 101 to stiffen. In some implementations, venting the jammer unit 101 by, for example, opening the inlet 108, actuating the valve to close the valve, or pumping the fluid into the interior of the membrane 106, reverses the stiffening process, allowing the portions of the backing layers 114 to slide past one another to restore the pliancy of the jammer unit 101.

The plurality of backing layers 114 are configured to support the substrate 112. The plurality of backing layers 114 may include one, two, three, four, five, six, seven, eight, nine, ten, or more backing layers. Each of the plurality of backing layers 114 may be at least partially overlapping such that at least a portion of one backing layer overlaps at least a portion of an adjacent backing layer. For example, as shown in FIG. 7, at least a portion of a first backing layer 114A at least partially overlaps at least a portion of a second backing layer 114B. Such partial overlapping positioning of the backing layers helps allow the jammer unit 101 to move freely in a relaxed, unstretched state and still sufficiently stiffen in a stiffened and/or stretched state. The plurality of backing layers 114 may be made of paper, plastic, rubber, or other materials.

The substrate 112 is coupled to the plurality of backing layers 114. For example, the substrate 112 may be coupled to the first backing layer 114A and the second backing layer 114B. The substrate 112 may connect each of the backing layers 114 to one another.

The substrate 112 may include a substrate material and a plurality of relief cuts 182. The substrate material may include one or more rigid materials, such as silicon carbide, nitrile, ceramic, and/or the like. Rigid substrate materials may provide improved support and/or protection to the wearer of the jammer unit 101. Additionally and/or alternatively, the substrate material may include one or more flexible materials, such as elastic, rubber, plastic, and/or the like.

The plurality of relief cuts 182 define openings in the substrate material of the substrate 112. The plurality of relief cuts 182 may be laser cut openings that extend through a thickness of the substrate material. The plurality of relief cuts 182 allow for a rigid substrate material to be incorporated in the jammer unit 101. The plurality of relief cuts 182 may allow the rigid substrate material to sufficiently stiffen upon evacuation of the fluid from the membrane 106, and fully return to its original relaxed state after evacuation ends and/or the membrane is vented. The plurality of relief cuts 182 may also allow the rigid substrate material to easily stretch and/or length due at least in part to the out-of-plane deformation of the plurality of backing layers 114. Such configurations may also allow the rigid substrate material to fully return to its original relaxed state after being stretched. In other words, the jammer unit 101 may shift from a first state to a second state in when the fluid is evacuated from the interior of the membrane 106 and/or when the jammer unit 101 is stretched. The plurality of relief cutes 182 allows the jammer unit 101 to fully return to the first state when the fluid is no longer being evacuated from the membrane 106 and/or when the jammer unit is no longer being stretched.

The plurality of relief cuts 182 may be positioned in a patterned array of relief cuts 182. For example, the plurality of relief cuts 182 may include a kirigami laser cut pattern that allows for the jammer unit 101 to freely stretch and/or lengthen.

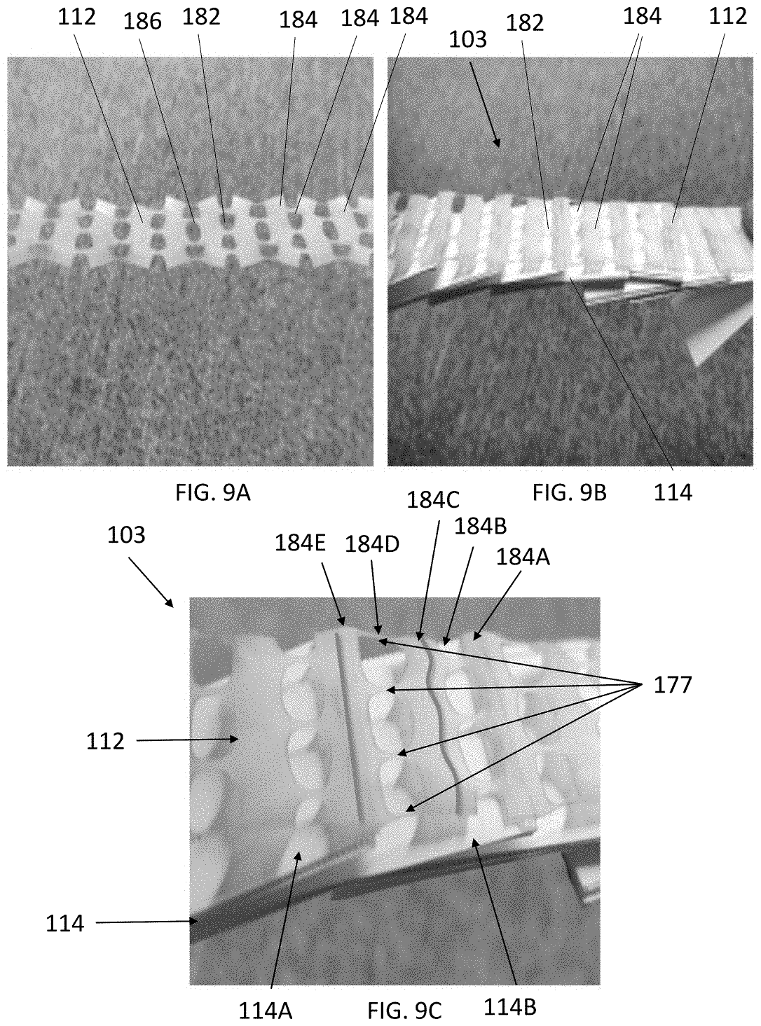

In some implementations, the substrate 112 includes alternating sets of rows 184. The alternating sets of rows includes a first row that does not have at least one relief cut of the plurality of relief cuts 182 and the second row includes at least one relief cut of the plurality of relief cuts 182. Each of the alternating sets of rows 184 may be positioned parallel to one another. Each of the alternating sets of rows 184 may be positioned adjacent to one another. In some implementations, portions 177 of the substrate material connect the adjacent rows and may be positioned perpendicular to the adjacent rows (see FIGS. 9A-9C).

In some implementations, the second row of a first alternating set of rows includes a first relief cut pattern and the second row of an adjacent second alternating set of rows includes a second relief cut pattern. The first relief cut pattern and the second relief cut pattern may be the same and/or different. For example, the relief cuts 182 in the first relief cut pattern may be arranged in the same and/or different manner as the relief cuts 182 in the second relief cut pattern.

For example, the substrate 112 may include a first set of rows 189 including a first row 189A and a second row 189B, and an adjacent second set of rows 183 including a first row 183A and a second row 183B. The second row 189B may include a first relief cut pattern of relief cuts 182 and the second row 183B may include a second relief cut pattern of relief cuts 182. As shown in FIG. 8, the second row 189B may include four relief cuts. The four relief cuts of the second row 189B may include at least two relief cuts that are surrounded by at least a portion of the substrate material and at least two lateral relief cuts. The lateral relief cuts have an open lateral side that is not surrounded by a portion of the substrate material and an opposing side that is surrounded by a portion of the substrate material. The two relief cuts surrounded by the portion of the substrate material are positioned between the two opposing lateral relief cuts 184. For example, the second row 189B may include a first relief cut and a second relief cut (e.g., the central relief cuts surrounded by the portion of the substrate material). The second row 189B may also include a first lateral portion of the substrate material positioned on a lateral side of the first relief cut, a second lateral portion of the substrate material positioned between the first relief cut and the second relief cut and positioned opposite the sixth lateral portion, and a third lateral portion of the substrate material positioned on a lateral side of the second relief cut opposite the second lateral portion.

Again referring to FIGS. 8 and 9A-9C, the second row 183B may include three relief cuts that are surrounded by a portion of the substrate material. For example, the second row 183B may include a first relief cut, a second relief cut, and a third relief cut. The second row 183B may also include a first lateral portion of the substrate material positioned on a first lateral side of the first relief cut, a second lateral portion of the substrate material positioned between the first relief cut and the second relief cut and positioned opposite the first lateral portion, a third lateral portion of the substrate material positioned between the second relief cut and the third relief cut and positioned opposite the second lateral portion, and a fourth lateral portion of the substrate material positioned on a second lateral side of the third relief cut opposite the third lateral portion.

In some implementations, every other row 184 of the substrate material that does not include a relief cut 182 is coupled to a backing layer 114. In other words, a first row of the substrate material that does not include a relief cut is coupled to a first backing layer 114 (e.g., the first backing layer 114A) and a next row of the substrate material that does not include a relief cut is not coupled to a second backing layer 114 (e.g., the second backing layer 114B). This configurations results in the first row being constrained and a next row of the substrate material that does not have a relief cut being freely movable and deformable. Such configurations allow for the substrate 112 to retain the out-of-plane deformation properties that allow for the backing layers 114 to easily stiffen, compress, and/or stretch, and then fully return to its original state. As an example, the substrate 112 may include a first row 184A that does not have at least one relief cut 182, a second row 184B that includes at least a first relief cut and a second relief cut separated by a portion of the substrate material, a third row 184C that does not have at least one relief cut 182, a fourth row 184D that includes at least one relief cut 182, and a fifth row 184E that does not have at least one relief cut 182. In this example, the first row 184A is coupled (e.g., adhered, fastened, and/or the like) to a first backing layer (e.g., the second backing layer 114B) and the fifth row 184E is coupled to an adjacent second backing layer (e.g., the first backing layer 114A), as shown in FIG. 9C.

The spacing between adjacent relief cuts 182, adjacent rows 184, and/or between rows that include relief cuts (e.g., the width of the rows that do not include relief cuts) can be optimized to enhance the properties of the jammer unit 101. For example, the substrate 112 may have a width 164 of approximately 63.75 mm, 5 to 10 mm, 10 to 20 mm, 20 to 30 mm, 30 to 40 mm, 40 to 50 mm, 50 to 60 mm, 60 to 70 mm, 70 to 80 mm, or longer or other ranges therebetween. The substrate 112 may have an overall length 162 of approximately 300 mm, 100 to 200 mm, 200 to 300 mm, 300 to 400 mm, lesser, greater, or other ranges therebetween.

In some implementations, a distance 166 between adjacent relief cuts 182 is approximately 4.25 mm, 2 to 3 mm, 3 to 4 mm, 4 to 5 mm, 5 to 6 mm, greater, lesser, or other ranges therebetween. In other words, a width of the portion of substrate material between adjacent relief cuts 182 is approximately 4.25 mm, 2 to 3 mm, 3 to 4 mm, 4 to 5 mm, 5 to 6 mm, greater, lesser, or other ranges therebetween. In some implementations, a width 168 of a relief cut that is entirely surrounded by substrate material is approximately 17 mm, 10 to 12 mm, 12 to 14 mm, 14 to 16 mm, 16 to 18 mm, 18 to 20 mm, greater, lesser, or other ranges therebetween. In other words the width 168 between opposing portions of the substrate material surrounding a relief cut is approximately 17 mm, 10 to 12 mm, 12 to 14 mm, 14 to 16 mm, 16 to 18 mm, 18 to 20 mm, greater, lesser, or other ranges therebetween. In some implementations a length 170 between rows having at least one relief cut 182 is approximately 19.35 mm, 16 to 18 mm, 18 to 20 mm, 20 to 22 mm, greater, lesser, or other ranges therebetween. In other words, the length 170 of a row that does not have at least one relief cut 182 is approximately 19.35 mm, 16 to 18 mm, 18 to 20 mm, 20 to 22 mm, greater, lesser, or other ranges therebetween. In some implementations, a maximum length between rows having at least one relief cut is greater than a maximum length of width of a relief cut. For example, the length 170 is greater than the width 168 to accommodate the adhesion of backing layers 114.

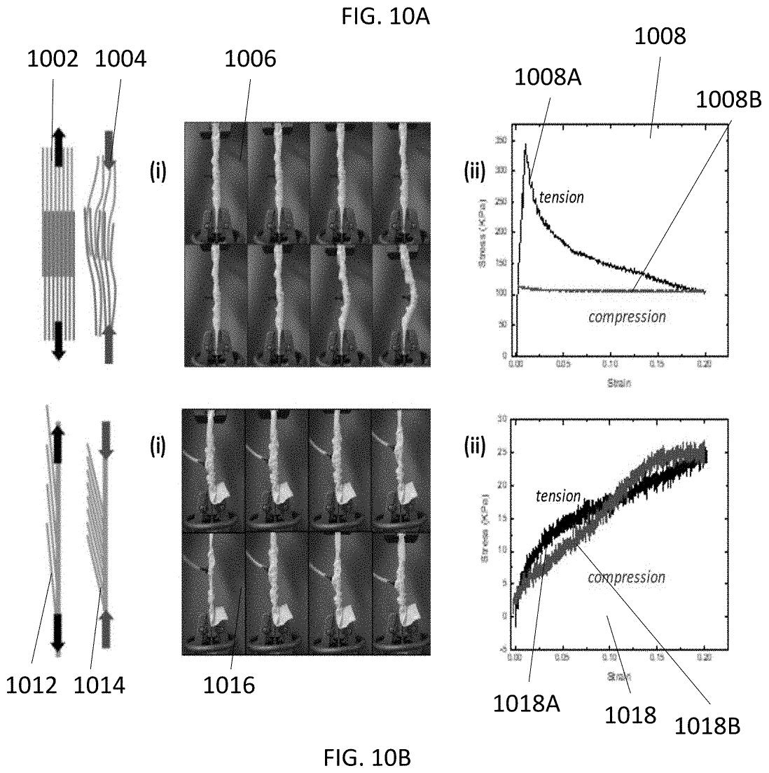

FIGS. 10A-10B depict a performance comparison between jammer devices, consistent with implementations of the current subject matter. For example, FIG. 10A depicts the performance of an interleaving layer jammer and FIG. 10B depicts the performance of the jammer unit 101 as shown in FIGS. 7-9C. In this example, the jammer unit 101 tested in FIG. 10B included eight stacks of a sketch paper substrate material, where each stack included five layers of sketch paper cut to 25.4 mm×76.2 mm. To create a jammer unit of comparable dimensions and paper mass, the interleaving jammer tested in FIG. 10A was designed with 14 interleaving layers of sketch paper cut to 25.4 mm×200 mm dimensions.

Both jammer units were mounted in tension in an Instron 3367 Dual Column Testing Systems device (Norwood, Mass.), pulled to 20% strain, and compressed down to their original length. The testing was completed with evacuation and then with evacuation at 20% strain. As shown in FIG. 10A, the interleaving layer jammer was unable to reversibly deform. For example, as shown at 1002, when lengthened, the interleaving layers separated, and upon shortening of the interleaving layers when returning the layers to the initial relaxed state, the interleaving layers buckle. The images at 1004 and 1006 show the bucking of the interleaving layers. The inability of the interleaving layers to reversibly deform makes it an undesirable configuration in applications requiring reversible length change. When the experiment was repeated with the same instrumentation, and with vacuum applied at full extension, the interleaving layers again separated upon stretching or lengthening. For example, the graph 1008 at 1008A shows a steep increase of stress to a peak of approximately 350 kPa followed by a sharp and asymptotic decline to approximately 100 kPa. This change in tension represents a transition from a near-static friction state to a kinetic friction state. After evacuation and venting, followed by compression, the interleaving layers remained at a plateau stress of 110 kPa. Because the layers of the interleaving layers remained in place, the layers undesirably behaved as a slender column of rectangular cross-section undergoing immediate mode I buckling.

As shown in FIG. 10B, however, the jammer unit 101 undergoing the testing was able to lengthen freely and then shorten after evacuation at 20% tensile strain (see 1012, 1014, and 1016 of FIG. 10B). Unlike in the interleaving layers jammer unit, in which adjacent layers slid past one another in plane, the arrangement of the backing layers 114 and substrate 112 translated the tension to out-of-plane displacement, allowing the backing layers 114 to separate and the jammer unit 101 to lengthen (see 1012). In compression, the backing layers 114 approached one another at a non-planar angle, allowing shortening of the jammer unit 101 (see 1014). The stress strain curve shown in graph 1018 (e.g., with evacuation and venting at 20% after tension and before compression) illustrates the improved ability for the jammer unit 101 to freely change shape (e.g., lengthen and compress). For example, the peak force during both tension, at 1018A, and compression, at 1018B, was approximately 25 kPa, which is significantly less than the peak forces exhibited by the interleaving layer jammer unit at 1008. Further, as shown at graph 1018, the tension and compression profile includes two linear regions of comparable slope. This configuration is favorable in the context of wearables, as a predictable and uniform resistance to elongation is beneficial to the wearer.

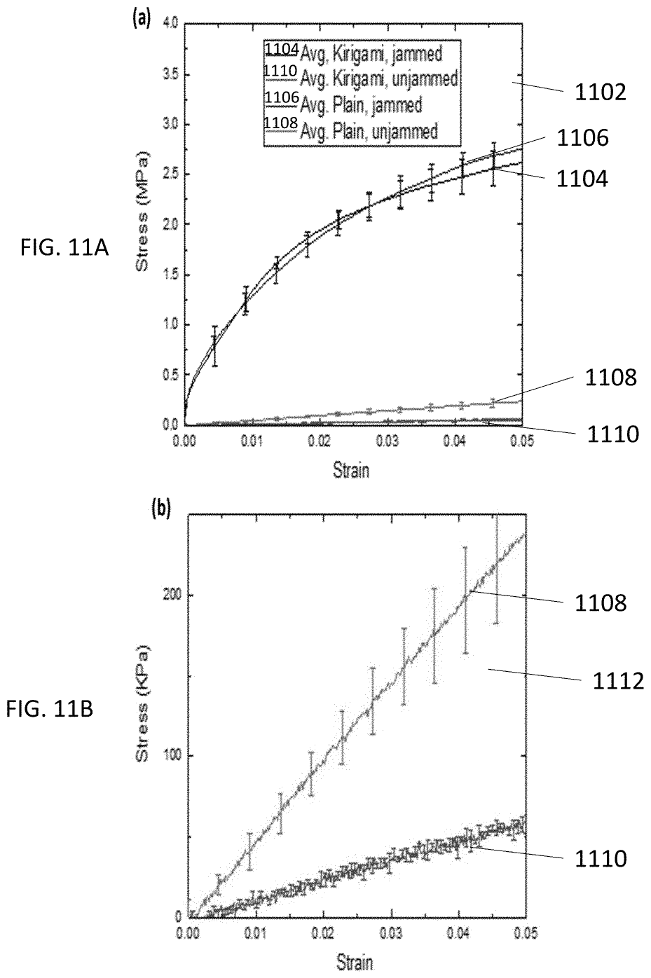

FIGS. 11A-11B depict example performance plots, consistent with implementations of the current subject matter. For example, FIG. 11A and FIG. 11B show the results of an experiment comparing the tensile and compression properties of the jammer units 101, with and without patterned (e.g., kirigami patterned) relief cuts (e.g., the relief cuts 182) and in a jammed (e.g., stiffened) and unjammed (e.g., relaxed) state. The tension experiments were performed to 5% strain. As illustrated by the graphs 1102 and 1112, shown in FIGS. 11A and 11B, respectively, the patterned relief cuts improve the ductility of the jammer unit and improve contact with a wearer in use. This is highlighted in FIG. 11B, which illustrates a comparison of the compression properties of the tested jammer units. As shown in FIG. 11B, under compression (e.g., when vented), the jammer unit with the patterned relief cuts exhibited a significantly lower stiffness (see 1108 in FIG. 11B) of approximately 1.0 MPa, compared to the jammer unit without the patterned relief cuts (see 1110 in FIG. 11B), which had a stiffness of approximately 4.6 MPa. As shown in FIG. 11A, the jammed jammer unit with the patterned relief cuts (see 1104) and the jammed jammer unit without the patterned relief cuts (see 1106) performed similarly under tension, and the unjammed jammer unit with the patterned relief cuts (see 1110) and the unjammed jammer unit without the patterned relief cuts (see 1108) performed similarly under tension.

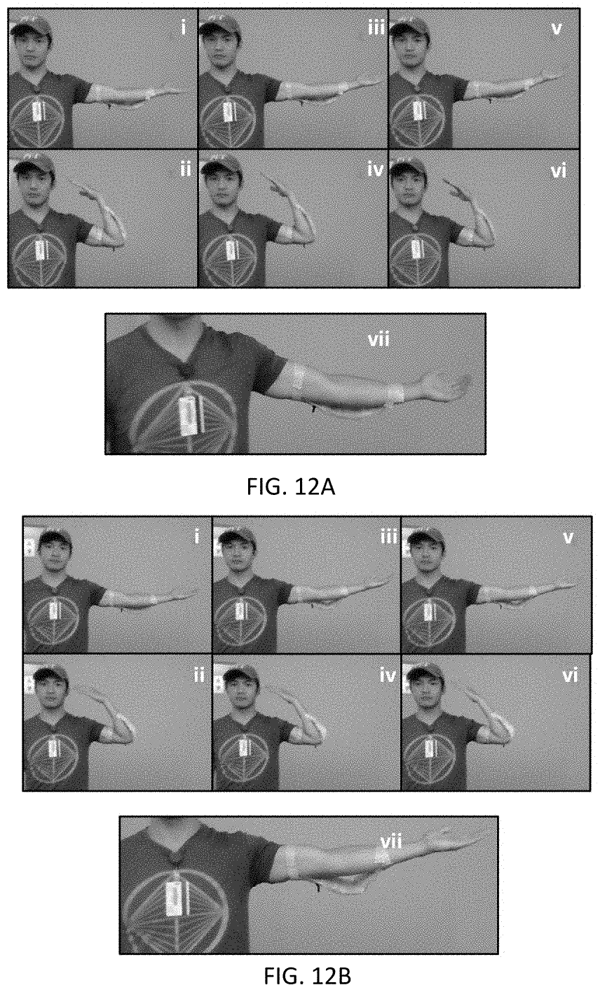

FIGS. 12A-12B depict images of a bend test, consistent with implementations of the current subject matter. To demonstrate the desirable characteristics of the jammer units 101 with relief cuts 182, samples were fabricated to cover the elbow of a wearer (see FIG. 12A), and compared to an interleaving layer jammer unit (see FIG. 12B). Both jammer units used the same total mass of the paper backing layer 114. As shown in the comparison between stage (i) and stage (vii) in FIG. 12A, the jammer unit 101 having the relief cuts retained its shape after three cycles of flexion and extension. As shown in the comparison between stage (i) and stage (vii) in FIG. 12B, the interleaving jammer unit buckled outwardly after only one cycle of extension and flexion.

FIGS. 13A-13D depict an example ganoid geometry for a jammer unit 101, consistent with implementations of the current subject matter. The example ganoid geometry of the jammer unit 101 shown in FIGS. 13A-13D may be implemented in the jammer system 100 described herein. For example, the jammer media 103 may include a plurality of ganoids 1304 arranged in a ganoid layer. In some implementations, the surfaces (e.g., the outer surface and/or one or more chamfered sides) of the ganoids 1304 may be curved to accommodate adjacent ganoid surfaces and to form uniform surfaces between adjacent ganoids 1304. In some implementations, the surfaces of the ganoids 1304 have a rhomboid shape (as shown in FIGS. 13A-13D), a hexagonal shape, a pentagon shape, and the like.

The chamfered sides of each of the ganoids 1304 may correspond to one another. For example, when adjacent ganoids 1304 abut one another, the chamfered sides may correspond to one another so that there is minimal or no overlap (e.g., imbrication) between adjacent ganoids. In some implementations, a degree of imbrication may indicate the amount of overlap between adjacent ganoids 1304. For example, a degree of imbrication may be equal to [exposed surface length of the ganoid]/[total surface length of the ganoid]. The degree of imbrication of the ganoids 1304 may be approximately 0.7. In some implementations, the degree of imbrication of the ganoids 1304 may be approximately 0.6, 0.8, 0.9, or more, whereas the degree of imbrication of scales used in scale jamming techniques may be approximately 0.5 or less. A high degree of imbrication may indicate that the ganoids overlap to a lesser degree, while a low degree of imbrication may indicate that the ganoids overlap to a greater degree and thus are less flexible. Accordingly, the ganoids 1304 may exhibit a greater degree of overlap than scales used in scale jamming techniques.

In some implementations, the outer surface of each of the ganoids 1304 may align with one another along a plane in a bent or unbent configuration. The alignment between outer surfaces of each of the ganoids 1304 forms a uniform outer surface. In some implementations, because of the uniform outer surface and the uniform thickness of the ganoid geometry, the one or more ganoids 1304 and/or layers of ganoids 1304 may be stacked onto other jamming materials and/or onto other ganoids 1304 or layers of ganoids 1304. Thus, the jammer media 103 may include various layers with gradients of mechanical properties that retain the flexibility of a single layer of ganoids 1304.

The ganoids 1304 may be bonded or otherwise coupled to a backing layer 1305. In some implementations, the backing layer may define one or more bridges, such as sinusoidal bridges 1302. For example, each of the ganoids may be coupled to one another by the sinusoidal bridges 1302. The sinusoidal bridges 1302 may have a sinusoidal shape. The sinusoidal bridges 1302 may be formed of a backing layer 1305. The backing layer 1305 may be laser cut to define the sinusoidal relief pattern as shown in FIG. 13B. FIG. 13A shows an uncut depiction of the backing layer 1306. The backing layer 1306 may be made of an elastic material, a polyethylene material, a rigid material, and/or the like. Referring to FIG. 13B, the sinusoidal bridges 1302 form a network of springs connecting the ganoids 1304. Accordingly, the sinusoidal bridges 1302 allow the ganoids 1304 to reversibly stretch and/or stiffen, return to its original state, and/or relieves the deformation stress in the ganoid layer, improving the moldability of the layers of ganoids 1304. Such configurations may define a jamming skin that is highly moldable and provides improved protection for the wearer.

As noted above, because ganoids 1304 can be stacked flush but retain their flexibility, multiple layers of ganoids 1304 on a backing layers, such as elastic backing layers (e.g., the backing layer 1305 and/or the sinusoidal bridges 1302) may be stacked. As an example, FIGS. 13B and 13C show layers of the ganoids 1304 and sinusoidal bridges 1302 stacked on top of one another. As shown in FIGS. 13B and 13C, the stacked ganoid layers can include a first ganoid layer 1306 and a second ganoid layer 1308. Each ganoid layer may include one or more ganoids 1304 and a backing layer, such as the sinusoidal bridges 1302. For example, the first ganoid layer 1306 may include first ganoids 1304A and first sinusoidal bridges 1302A, and the second ganoid layer 1308 may include second ganoids 1304B and second sinusoidal bridges 1302B. Since ganoids can range from very stiff to very soft, the jammer unit 101 can be stretchable with a mechanical property gradient. For example, the first ganoid layer 1306 and the second ganoid layer 1308 may have different mechanical properties. As an example, the first ganoid layer 1306 can be hard or stiff, while the second ganoid layer 1308 can be soft. Such configurations can provide an adaptable jammer unit 101. Such configurations may also provide comfort for the wearer, while also maintaining a high degree of protection.

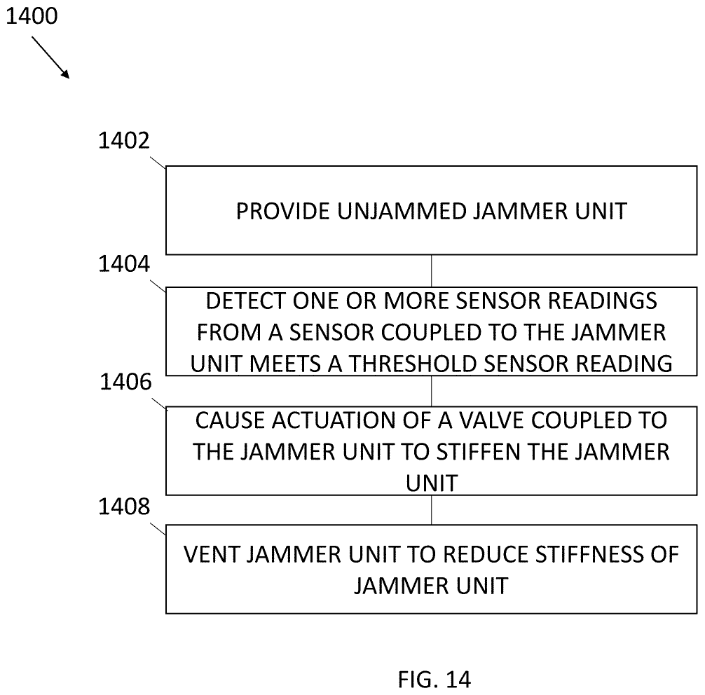

FIG. 14 depicts an example method 1400 of implementing a jammer unit, such as the jammer unit 101 consistent with implementations of the current subject matter.

At 1402, an unjammed jammer unit is provided. The unjammed jammer unit may be in an initial, relaxed state. In this configuration, the unjammed jammer unit may freely move, at least in part due to one or more relief cuts (e.g., the relief cuts 182) in the substrate of the jammer media (e.g., the jammer media 103).

At 1404, a controller (e.g., the controller 110) may detect one or more sensor readings from a sensor (e.g., the sensor 150) coupled to the jammer unit meets (e.g., is greater than or equal to) a threshold sensor reading. For example, the sensor may record one or more sensor readings, such as a rate of acceleration, a pressure, a temperature, an amount of moisture, a distance from an object, a sound level, and/or the like. The controller 110 may receive the one or more sensor readings from the sensor 150.

At 1406, the controller may cause actuation of a valve (e.g., the valve 115) coupled to the jammer unit to cause stiffening of the jammer unit. For example, when the controller determines that the one or more sensor readings meets (e.g., is greater than or equal to) the threshold sensor reading, the controller actuates the valve to, for example, stiffen the jammer unit and/or the jammer media. In other words, the actuation of the valve causes fluid to evacuated from the jammer unit to stiffen the jammer unit. In an example, an accelerator may detect an acceleration that is greater than or equal to a threshold acceleration, a proximity sensor may detect a proximity of an object or another person that is within a threshold proximity, a moisture sensor may detect a moisture level that meets a threshold moisture level, and/or a temperature sensor may detect a temperature that meets a threshold temperature.

At 1408, the jammer unit may be vented to reduce the stiffness of the jammer unit. For example, when the controller determines the one or more sensor readings is less than or equal to the threshold sensor reading, the controller may actuate the valve to vent the jammer unit to allow fluid to fill the jammer unit.

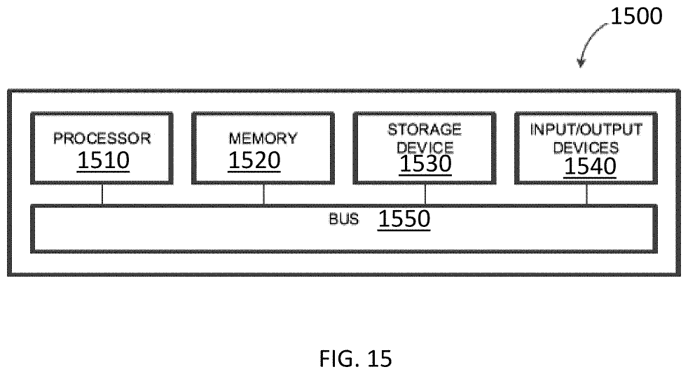

FIG. 15 depicts a block diagram illustrating a computing system 1500 consistent with implementations of the current subject matter. Referring to FIGS. 2 and 15, the computing system 1500 can be used to implement the jammer system 100, such as the controller 110, the client 120, the database 140, the sensor 150, the detector 152, the valve 115, the jammer unit 101, and/or any components therein.

As shown in FIG. 15, the computing system 1500 can include a processor 1510, a memory 1520, a storage device 1530, and indication/output devices 1540. The processor 1510, the memory 1520, the storage device 1530, and the indication/output devices 1540 can be interconnected via a system bus 1550. The processor 1510 is capable of processing instructions for execution within the computing system 1500. Such executed instructions can implement one or more components of, for example, the system 100. In some example embodiments, the processor 1510 can be a single-threaded processor. Alternately, the processor 1510 can be a multi-threaded processor. The processor 1510 is capable of processing instructions stored in the memory 1520 and/or on the storage device 1530 to display graphical information for a user interface provided via the indication/output device 1540.

The memory 1520 is a computer readable medium such as volatile or non-volatile that stores information within the computing system 1500. The memory 1520 can store data structures representing configuration object databases, for example. The storage device 1530 is capable of providing persistent storage for the computing system 1500. The storage device 1530 can be a floppy disk device, a hard disk device, an optical disk device, a tape device, a solid state device, and/or other suitable persistent storage means. The indication/output device 1540 provides indication/output operations for the computing system 1500. In some example embodiments, the indication/output device 1540 includes a keyboard and/or pointing device. In various implementations, the indication/output device 1540 includes a display unit for displaying graphical user interfaces.

According to some example embodiments, the indication/output device 1540 can provide indication/output operations for a network device. For example, the indication/output device 1540 can include Ethernet ports or other networking ports to communicate with one or more wired and/or wireless networks (e.g., a local area network (LAN), a wide area network (WAN), the Internet).

In some example embodiments, the computing system 1500 can be used to execute various interactive computer software applications that can be used for organization, analysis and/or storage of data in various formats. Alternatively, the computing system 1500 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the indication/output device 1540. The user interface can be generated and presented to a user by the computing system 1500 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one indication device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide indication to the computer. Other kinds of devices can be used to provide for interaction with a user as well. For example, feedback provided to the user can be any form of sensory feedback, such as for example visual feedback, auditory feedback, or tactile feedback; and indication from the user may be received in any form, including acoustic, speech, or tactile indication. Other possible indication devices include touch screens or other touch-sensitive devices such as single or multi-point resistive or capacitive track pads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A jammer system, comprising:
a jammer unit comprising: a jammer media; and a membrane comprising an inlet, the membrane configured to surround the jammer media;
a valve coupled to the jammer unit, the valve configured to allow a fluid to pass through the inlet of the membrane; and
a sensor coupled to the valve, the sensor configured to cause actuation of the valve to evacuate the fluid from an interior of the membrane, the evacuation of the fluid from the interior of the membrane resulting in stiffening of the jammer media within the membrane.

2. The jammer system of claim 1, wherein the sensor is one or more of positioned on the jammer unit and positioned within the jammer unit.

3. The jammer system of claim 1, wherein the sensor is wirelessly coupled to the valve.

4. The jammer system of claim 1, wherein the sensor comprises one or more of an accelerometer, a pressure sensor, a heat sensor, a moisture sensor, a proximity sensor, and a sound sensor.

5. The jammer system of claim 1, wherein the sensor is configured to cause actuation of the valve when a sensor reading of the sensor meets a threshold sensor reading.

6. The jammer system of claim 1, further comprising a controller, the controller comprising at least one data processor; and at least one memory storing instructions, which, when executed by the at least one data processor, result in operations comprising: actuating the valve when a sensor reading of the sensor meets a threshold sensor reading.

7. The jammer system of claim 1, wherein the sensor is configured to cause actuation of the valve to a first position when a first sensor reading of the sensor is greater than or equal a threshold sensor reading; and wherein the sensor is configured to cause actuation of the valve to a second position when a second sensor reading of the sensor is less than the threshold sensor reading.

8. The jammer system of claim 7, wherein in the first position, the fluid is evacuated from the interior of the membrane, resulting in the stiffening of the jammer media from a relaxed state; and wherein in the second position, the fluid is allowed to fill the interior of the membrane, resulting in the jammer media returning to the relaxed state.

9. The jammer system of claim 1, wherein the jammer media comprises a combined jammer unit formed of a first layer comprising a first reversibly stiffening material; and a second layer comprising a second reversibly stiffening material.

10. The jammer system of claim 1, wherein the jammer media comprises:
a first backing layer;
a second backing layer overlapping the first backing layer; and
a substrate coupled to the first backing layer and the second backing layer, the substrate comprising: a substrate material; and a plurality of relief cuts defining openings in the substrate material.

11. The jammer system of claim 10, wherein the substrate comprises a rigid material.

12. The jammer system of claim 10, wherein the plurality of relief cuts are positioned in a patterned array of relief cuts.

13. The jammer system of claim 10, wherein the substrate comprises alternating sets of rows, the alternating sets of rows comprising a first row that does not have at least one relief cut of the plurality of relief cuts; and a second row that has at least one relief cut of the plurality of relief cuts.

14. The jammer system of claim 13, wherein the alternating sets of rows are positioned parallel to one another.

15. The jammer system of claim 1, wherein the jammer media comprises a plurality of ganoids; and a plurality of sinusoidal bridges configured to couple the plurality of ganoids.

16. A jammer unit, comprising:
a first backing layer;
a second backing layer overlapping the first backing layer;
a substrate coupled to the first backing layer and the second backing layer, the substrate comprising a substrate material; and a plurality of relief cuts defining openings in the substrate material; and
a membrane comprising an inlet, the membrane configured to surround the first backing layer, the second backing layer, and the substrate;
wherein the jammer unit is configured to stiffen when fluid from an interior of the membrane is evacuated via the inlet.

17. The jammer unit of claim 16, wherein the substrate comprises a rigid material.

18. The jammer unit of claim 16, wherein the plurality of relief cuts are positioned in a patterned array of relief cuts.

19. The jammer unit of claim 16, wherein the substrate comprises alternating sets of rows, the alternating sets of rows comprising a first row that does not have at least one relief cut of the plurality of relief cuts; and a second row that has at least one relief cut of the plurality of relief cuts.

20. A method, comprising:
receiving a sensor reading from a sensor coupled to a jammer unit, the jammer unit comprising: a jammer media; and a membrane comprising an inlet, the membrane configured to surround the jammer media;
detecting the sensor reading meets a threshold sensor reading; and
causing, based on the detecting, actuation of a valve coupled to the membrane to cause evacuation of a fluid from an interior of the membrane, the evacuation of the fluid from the interior of the membrane resulting in stiffening of the jammer media within the membrane.
